(19) United States
(12) Patent Application Publication
(10) Pub. No.: US 2015/0164302 A1
(43) Pub. Date: Jun. 18, 2015

(54) Shoe Cleaning Device

(71) Applicant: Abram Peters, Winnipeg (CA)

(72) Inventor: Abram Peters, Winnipeg (CA)

(21) Appl. No.: 14/278,038

(22) Filed: May 15, 2014

Related U.S. Application Data
(60) Provisional application No. 61/917,088, filed on Dec. 17, 2013.

(51) Int. Cl. A47L 23/02; A47L 23/20; A47L 23/18; F26B 21/00

(52) U.S. Cl. CPC A47L 23/02; F26B 21/004; A47L 23/20; A47L 23/18

(57) ABSTRACT

The shoe cleaning station for removing snow, moisture, sand, salt and other light debris off footwear should be conveniently located in entrances where the wearer upon entering can clean his or her foot wear by slowly drawing the footwear over the vacuum and forced air slots located on the surface of the apparatus. This action is helpful since once the foot wear is cleaned the wearer will no longer track moisture, sand, and other debris into homes, offices, and apartments. This action will lead to a much cleaner environment and reduce cleaning costs and wear on flooring.

This application claims the benefit under 35 USC 119 (e) of Application 61/917,088 flied Dec. 17, 2013.

This invention relates to a shoe cleaning device for rapid removal of dirt, sand, salt, snow, and moisture, due to rain or snow from outdoor footwear at entrances of buildings.

In climates where snow and moisture from rain can collect and remain on the ground for extended periods, there is a serious problem where persons walking outside can track on their shoes snow, moisture and dirt into a building when they enter.

In some cases such as in private homes it is suitable for the footwear to be removed as the wearer enters the building at an entrance area so that the snow, moisture and dirt are not tracked into the building.

In other cases where the building may be a commercial building or apartment entrance, it is not suitable for the wearer to remove the footwear at the entrance. In this case it is typical that the wearer tracks the moisture from snow and rain on the shoe into the interior of the building where it leaves water as the snow melts which often contains sand and other unpleasant debris which stains the interior flooring.

The intention therein is not to provide a shoe cleaning system which leaves the shoes polished or attractive but instead only to remove quickly from the footwear snow and moisture to prevent this from being carried into the interior of the building. The operation must be rapid and easy to avoid line-ups at the entrance.

The problem of snow collecting on footwear is particularly difficult where the footwear is heavily grooved in a manner which is typical in winter footwear.

### SUMMARY OF THE INVENTION

It is one object of the present invention therefore to provide an apparatus for removing snow and moisture and associated materials from the footwear of a wearer entering an area from the exterior.

According to the invention, there is provided an apparatus for removing snow, moisture and associated dirt, sand and salt from outdoor footwear, the apparatus comprising:

a housing for placement on a floor surface in entrances;

a top surface of the housing being arranged for a wearer of the footwear to stand while moving the footwear across the top surface;

a forced air outlet on the top surface of the housing for loosening dirt and applying a drying air jet while the wearer moves the footwear slowly over the outlet slot one shoe at a time;

a vacuum inlet on the top surface of the housing for extracting debris and moisture while the wearer moves the footwear slowly over the inlet slot;

the vacuum inlet and the outlet being arranged on the top surface so that the footwear engages one after the other as the footwear is moved.

Preferably the vacuum inlet and the forced air outlet are spaced on the top surface so that both engage the footwear simultaneously so that the outlet directs air to the vacuum inlet to carry moisture to the vacuum inlet.

Preferably the vacuum inlet and the outlet comprise parallel slots.

Preferably there is provided a vacuum machine for generating an airflow and wherein the vacuum inlet is connected to an inlet of the vacuum machine and the outlet is connected to an outlet of the vacuum machine.

Preferably the vacuum machine is located in a separate housing portion at one side of the housing.

Preferably the housing includes first and second compartments underneath the top surface at the inlet and outlet respectively and wherein the vacuum machine is connected to ends of the compartments at one side of the housing.

Preferably elbows and accordion hoses are used to connect the compartments to the forced air and vacuum ports of the vacuum machine.

Preferably there are no moving brush elements on the housing so that the moisture is removed solely by air movement.

Preferably there is provided a recessed area in the top surface between the two slots for the airflow to make contact with the sole the shoe for drying.

Preferably the outlet forms a slot shaped nozzle arranged to direct the air onto the top surface in a direction along the top surface and toward the vacuum inlet.

Preferably the housing has a railing approximately 3 feet high and attached to the rear of the housing for the wearer to grip and to provide balance while the wearer slowly moves the footwear over the inlet and outlet slots.

Preferably a momentary switch located in the railing is activated and deactivated as the wearer grips and releases the railing.

Preferably a connector is located in the housing of the vacuum machine so that the housing and the vacuum machine can be easily separated for moving and cleaning.

Preferably the dirt, snow and moisture will be removed from the outdoor footwear solely by the movement of air through the vacuum inlet and the forced air outlet located on the floor of the housing of the station.

Preferably there is a shelf for shoe cleaning accessories and a manually operable brush on a long handle for the use of the wearer at the station.

The shoe cleaner will not remove mud or dirt or other debris that is dried on to the sole of the footwear. Also it will not clean the sides and top of the footwear. The shoe cleaning devise is not designed to be suitable for use in entrances where there are is a lot of traffic as in stores, schools, or malls where excessive line-ups might arise.

The arrangement thus provides a vacuum inlet for extracting debris and moisture, while the footwear is passed slowly over the vacuum inlet and an angled forced air outlet for loosening debris and drying the sole of the footwear while it is slowly passed over the forced air outlet;

Preferably there is shelving, as an integrated part Of the shoe cleaning station to provide for the storage of cleaned footwear, mitts, headgear, and hooks for jackets when the shoe cleaner is located in the front entrance of a home or other such suitable space.

The shoe cleaner as described in more detail hereafter runs on a vacuum cleaner with not less than 5.5 hp.

### BRIEF DESCRIPTION OF THE DRAWINGS

One embodiment of the invention will now be described in conjunction with the accompanying drawings in which:

FIG. 1 is an isometric view of the shoe cleaning device according to the present invention.

FIG. 2 is an isometric inside view of the housing of the station showing the vacuum and the forced air chambers.

FIG. 3 is a schematic illustration of the floor of the station showing the shape and location of the vacuum inlet and the forced air outlet.

FIG. 4 is a schematic of the electrical component for the momentary switch and the connector.

### DETAILED DESCRIPTION

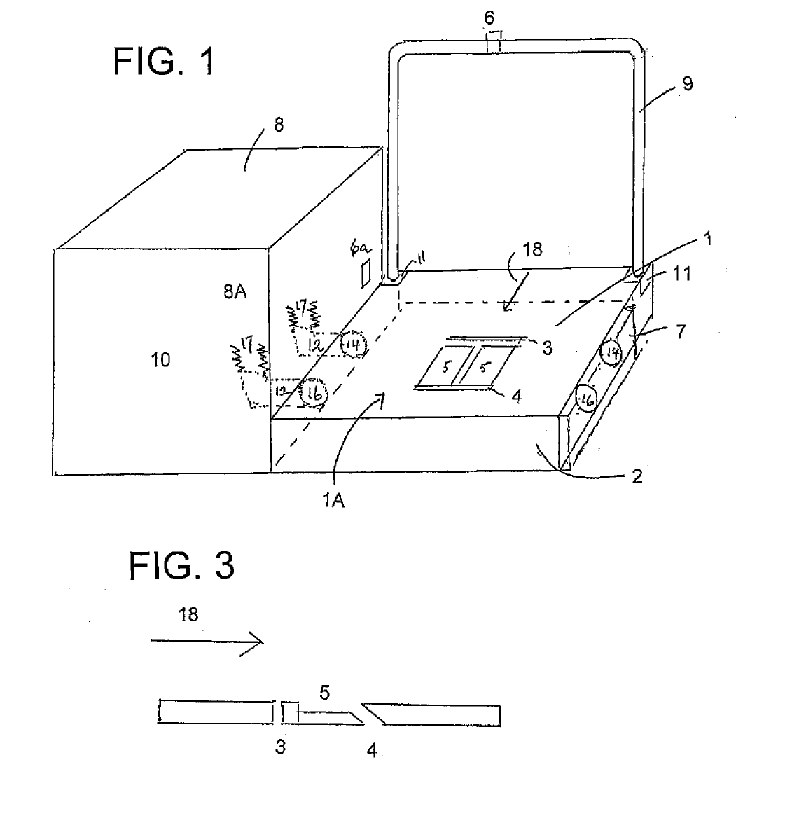

The apparatus for cleaning the sole of outdoor footwear shown in FIG. 1 includes the station or housing 1 arranged with a base 2 for sitting on a supporting floor surface and a top surface 1A at which the wearer can stand while slowly moving each foot over the slots 3 and 4. In the top surface 1A is located a vacuum inlet slot 3, which will remove debris and moisture, and a forced air outlet slot 4, which will loosen the remainder of the debris and dry the sole of the footwear. A recessed area 5 between the two slots is the area for the airflow to make contact with the sole of the shoe for drying. The recess 5 thus provides a space between the sole of the footwear and the top surface. Within the housing underneath the slots are compartments 3A and 4A extending across the housing with the slots extending only over a part of the width of the housing sufficient to extend across the foot wear. Each side of the housing has round openings 14 and 16 connected with the compartments in which elbows 12 are inserted and the accordion hoses 17 are connected to the vacuum machine 8A located inside the housing 8 for the vacuum machine.

The station includes a stantion or rail 9 for the hands of the wearer to ensure balance and safety while moving the footwear over the slots. Angle brackets 11 are located at the base of the housing to hold the rail firmly to the station.

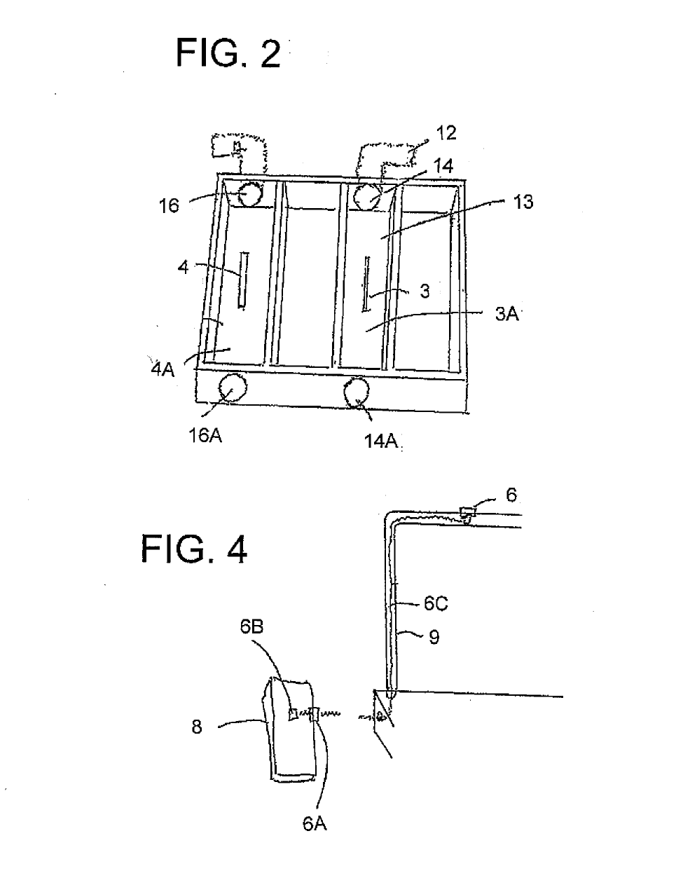

FIG. 2 provides an inside view of the housing of the station. The housing has two main compartments 4A and 3A. The intake compartment 3A allows the air to pass from the intake slot 3 to the vacuum machine 8A through opening 14. The forced air compartment 4A allows air to flow from the vacuum machine through opening 16 and then through the forced air outlet 4.

The housing 1 has openings 14, 16 on both sides so that the vacuum machine can be connected to either side of the housing. A cover or cap 7 is placed over the openings that are not in use. To clean the intake and forced air compartments the cover 7 is removed.

FIG. 3 shows the side view of the top surface 1A of the housing which defines the floor of the station. The forced air outlet 4 is shaped at an angle to the top surface to define a nozzle angled as shown so that the air is directed to flow toward the outlet 3 across the top surface. A recessed area 5 is formed in the top surface between the two slots so that the air from the nozzle 4 is directed into the recessed area and then to the vacuum slot 3. The wearer is instructed to move the footwear rearwardly in the direction of the arrow 18 so that the footwear moves across the slots gradually and the slot 4 directs warm or heated air onto the bottom of the footwear and into the area underneath the footwear at the recess 5 to blow snow, dirt and any moisture to the slot 3.

FIG. 4 shows the location of the momentary switch 6 on the railing 9 and the connector 6A on the housing of the vacuum. The switch on the vacuum motor 6B is rewired to the connector 6A and the protective cable 6C from the connector to the momentary switch 6 passes through the railing. The railing is of sufficient diameter to hold the momentary switch 6.

The vacuum inlet 3 and the outlet slot or nozzle 4 for slots which are spaced on the top surface by a distance of the order of 4 to 6 inches so that both engage the footwear simultaneously as the wearer slides the footwear along the direction 17A so that the outlet directs air to the vacuum inlet to carry moisture to the vacuum inlet.

The cleaning or removal of moisture and snow carrying dirt and sand is effected solely by the air flow as there are no moving brush elements on the housing.

The recessed area 5 in the top surface between the two slots 3, 4 is the area for the airflow to make contact with the sole of the shoe for drying.

A shelving for the placement of shoe cleaning accessories can be provided by the top surface of the housing 8 or as a separate shelf attached to the rail 9 for the placement of footwear after it has been cleaned.

A long handle brush can be provided at the rail 9 for manual cleaning the snow off the top and side of the footwear if required.

Since various modifications can be made of my invention as herein and above described, and many apparently widely different embodiments of the same made within the spirit and scope of the claims without departing from such spirit and scope, it is intended that all matter contained in the accompanying specification shall be interrupted as illustrative and not in a limiting sense.

1. Apparatus for removing snow and moisture and associated dirt, sand and salt from outdoor footwear, the apparatus comprising:
a housing for placement on a floor surface;
a top surface of the housing being arranged for a wearer of the footwear to stand while moving the footwear across the top surface;
a forced air outlet on the top surface of the housing for loosening dirt and applying a drying air jet while the wearer moves the footwear slowly over the outlet slot one shoe at a time;
a vacuum inlet on the top surface of the housing for extracting debris and moisture while the wearer moves the footwear slowly over the inlet slot;
the vacuum inlet and the outlet being arranged on the top surface so that the footwear engages one after the other as the footwear is moved.

2. The apparatus according to claim 1 wherein the vacuum inlet and the outlet are spaced on the top surface so that both engage the footwear simultaneously so that the outlet directs air to the vacuum inlet to carry moisture to the vacuum inlet.

3. The apparatus according to claim 1 wherein the vacuum inlet and the outlet comprise parallel slots.

4. The apparatus according to claim 1 wherein there is provided a vacuum machine for generating an airflow and wherein the vacuum inlet is connected to an inlet of the vacuum machine and the outlet is connected to an outlet of the vacuum machine.

5. The apparatus according to claim 1 wherein the vacuum machine is located in a separate housing portion at one side of the housing.

6. The apparatus according to claim 1 wherein the housing includes first and second compartments underneath the top surface at the inlet and outlet respectively and wherein the vacuum machine is connected to ends of the compartments at one side of the housing.

7. The apparatus according to claim 6 wherein elbows and accordion hoses are used to connect the compartments to the forced air and vacuum ports of the vacuum machine.

8. The apparatus according to claim 1 wherein there are no moving brush elements on the housing so that the moisture is removed solely by air movement.

9. The apparatus according to claim 1 wherein there is provided a recessed area in the top surface between the two slots is the area for the airflow to make contact with the sole of the shoe for drying.

10. The apparatus according to claim 1 wherein the outlet forms a slot shaped nozzle arranged to direct the air onto the top surface in a direction along the top surface and toward the vacuum inlet.

11. The apparatus according to claim 1 wherein there is provided a railing adjacent the housing for holding by the wearer.

12. The apparatus according to claim 1 wherein there is provided a switch located on the railing for starting and stopping the vacuum machine.

13. The apparatus according to claim 1 wherein a connector is located in the housing of the vacuum machine so that the housing and the vacuum machine can be easily separated for moving and cleaning.

14. The apparatus according to claim 1 where the dirt, snow and moisture is removed from the outdoor footwear solely by the movement of air through the vacuum inlet and the forced air outlet located on the floor of the housing of the station.

15. The apparatus according to claim 1 where the housing includes a stantion with a momentary switch for a person to grip for balancing and for activating and deactivating the switch while moving the footwear slowly over the vacuum and forced air slots.

16. The apparatus for claim 1 wherein there is provided shelving for the placement of shoe cleaning accessories and for the placement of footwear after it has been cleaned.

17. The apparatus according to claim 1 wherein there is a long handle brush for manual cleaning the snow off the top and side of the footwear if required.
